(19) United States
(12) Patent Application Publication
(10) Pub. No.: US 2021/0307308 A1
(43) Pub. Date: Oct. 7, 2021

(54) Fishing Device

(71) Applicant: W. Mark Knight, Nashville, TN (US)

(72) Inventor: W. Mark Knight, Nashville, TN (US)

(21) Appl. No.: 13/531,321

(22) Filed: Jun. 22, 2012

(51) Int. Cl. A01K 89/016; A01K 87/04

(52) U.S. Cl. CPC A01K 89/016; A01K 87/04

(57) ABSTRACT

A clamp device to clamp to a fishing pole and strip fishing line may include a first clamp member, a second clamp member to pivotably connect to the first clamp member, and a spool member to connect to the first clamp member and the second clamp member to the fishing rod and to rotate and to strip fishing line. The first clamp member may include a first clamp pivoting device. The second clamp member may include a second clamp pivoting device. The first clamp member may include a first clamp arm. The second clamp member may include a second clamp arm. The first clamp arm may include a first clamp slot.

### FIELD OF THE INVENTION

The present invention relates to fishing apparatus and more particularly to a clamping device which may clamp onto a fishing pole and strip the fishing line from the fishing reel.

### BACKGROUND

Devices to strip a line from a spool are known, and U.S. Pat. No. 4,635,406 discloses an apparatus useful for stripping a line from a spool and dressing the point of a fish hook. The apparatus includes a housing provided with an inlet port and an exit port through which the line to be stripped from a spool is drawn, and an aperture through which a sharpening member projects. A motor mechanism is disposed within the housing, operatively connected to a roller mechanism aligned with the inlet and exit ports. The roller mechanism is arranged to engage and transport the free end of a line inserted into the inlet port through the housing and out the exit port, thereby stripping the line from the spool.

### SUMMARY

A clamp device to clamp to a fishing pole and strip fishing line may include a first clamp member, a second clamp member to pivotably connect to the first clamp member, and a spool member to connect to the first clamp member and the second clamp member to the fishing rod and to rotate and to strip fishing line.

The first clamp member may include a first clamp pivoting device.

The second clamp member may include a second clamp pivoting device.

The first clamp member may include a first clamp arm.

The second clamp member may include a second clamp arm.

The first clamp arm may include a first clamp slot.

The second clamp arm may include a second clamp slot.

The spool member may include a first spool.

The spool member may include a second spool.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of a clamp device of the present invention;

FIG. 2 illustrates a perspective view of the clamp device of the present invention;

FIG. 3 illustrates a perspective view of the clamp device of the present invention;

FIG. 4 illustrates a top view of the clamp device of the present invention;

FIG. 5 illustrates a side view of the clamp device of the present invention;

FIG. 6 illustrates another side view of the clamp device of the present invention;

FIG. 7 illustrates a sectional view of the clamp device of the present invention;

FIG. 8 illustrates a sectional view of the clamp device of the present invention;

FIG. 9 illustrates a sectional view of the clamp device of the present invention;

FIG. 10 illustrates a sectional view of the clamp device of the present invention;

FIG. 11 illustrates a sectional view of the clamp device of the present invention;

FIG. 12 illustrates a top view of the first clamp member of the clamp device of the present invention;

FIG. 13 illustrates a perspective view of the first clamp member of the clamp device of the present invention;

FIG. 14 illustrates a side view of the first clamp member of the clamp device of the present invention;

FIG. 15 illustrates a back view of the first clamp member of the clamp device of the present invention;

FIG. 16 illustrates a perspective view of the clamp device of the present invention;

FIG. 17 illustrates a side view of the first spool of the present invention;

FIG. 18 illustrates a front view of the first spool of the present invention;

FIG. 19 illustrates a perspective view of the first spool of the present invention;

FIG. 20 illustrates a side view of the second spool of the present invention;

FIG. 21 illustrates a perspective view of the second spool of the present invention;

FIG. 22 illustrates a front view of the second spool of the present invention;

FIG. 23 illustrates a cross-sectional side view of the spool shaft of the present invention;

FIG. 24 illustrates an end view of the spool shaft of the present invention;

FIG. 25 illustrates a side view of the spool shaft of the present invention;

FIG. 26 illustrates a top view of the spool shaft of the present invention;

FIG. 27 illustrates a perspective view of the spool shaft of the present invention;

FIG. 28 illustrates a first end view of the horizontal shaft of the present invention;

FIG. 29 illustrates a top view of the horizontal shaft of the present invention;

FIG. 30 illustrates a second end view of the horizontal shaft of the present invention;

FIG. 31 illustrates a perspective view of the horizontal shaft of the present invention.

FIG. 32 illustrates a perspective view of a fishing reel driver of the present invention;

FIG. 33 illustrates a side view of the fishing reel driver of the present invention;

FIG. 34 illustrates a top view of the fishing reel driver of the present invention;

FIG. 35 illustrates a side view of the fishing reel driver shaft of the present invention;

FIG. 36 illustrates a perspective view of the fish line reel of the present invention;

FIG. 37 illustrates a perspective view of the fishing rod clamp of the present invention in an open position;

FIG. 38 illustrates a perspective view of the fishing rod clamp of the present invention in the closed position;

FIG. 39 illustrates a perspective view of the fishing line guide of the fishing line take-up reel device of the present invention;

FIG. 40 illustrates a side view of the fishing line guide of the present invention;

FIG. 41 illustrates an end view of the fishing line guide of the present invention;

### DETAILED DESCRIPTION

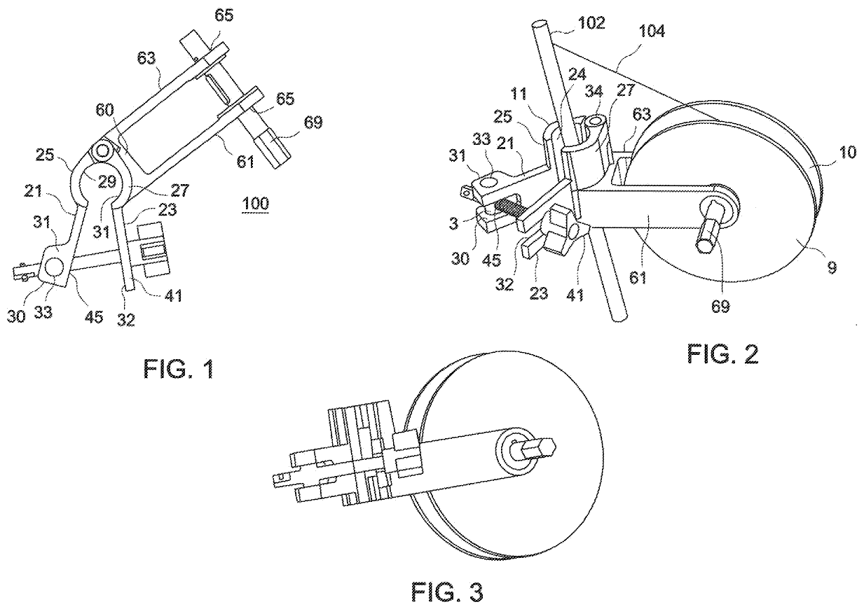

FIG. 1 illustrates a top view of the clamp and strip device 100 of the present invention, and the clamp device 100 may include a first clamp member 1 which may include a first clamp arm 21 which may include a first clamping pivoting device 25 which may have a first inner surface 29 which may be concavely curved to clamp an object and which may have a rectangular cross-section and may include a first clamping arm 21 connected to the first clamping pivoting device 25 and having a rectangular cross-section. The clamp device 100 may be rigid and may be formed from metal, plastic, wood or other appropriate material The first clamping arm 21 may include a wide section 31 at a proximal end of the first clamping arm 21. The wide section 31 may include a central aperture 33 which may be a vertical aperture to cooperate with a shaft 3.

The clamp device 100 may include a second clamp member 41 which may include a second clamp arm 23 which may include a second clamping pivoting device 27 which may have a second inner surface 31 which may be concavely curved to clamp an object by cooperating with the first inner surface 29 and which may have a rectangular cross-section and may include a second clamping arm 23 connected to the second clamping pivoting device 27 and having a rectangular cross-section. The second clamping arm 23 may include a second clamping slot 32 to cooperate with a horizontal shaft 4.

The vertical shaft 3 may include a horizontal aperture 45 which may be threaded to cooperate with the horizontal shaft 4.

By turning the handle 14, the horizontal shaft 4 turns and depending on the direction of the rotation of the shaft 4, the first clamp member 1 may approach the second clamp member 41 to close the clamp, or the first clamp member 1 may move away from the second clamp member 41 to open the clamp.

The clamp device 100 additionally may include a spool member 2 which may include a base member 60 which may be connected to the first and second clamp member 1, 41. The spool member 2 may strip the fishing line. The base member 60 may include a first spool arm 61 which may extend from the base member 60 and a second spool arm 63 which may extend from the base member 60 and which may be positioned in an opposed relationship and parallel to the first spool arm 61. The first spool arm 61 may have a spool aperture 65 at a distal end of the first spool arm 61 which may be substantially horizontal, and the second spool arm 63 may have a mirror spool aperture 65 at the distal end of the second spool arm 63 and which may be substantially horizontal. A spool shaft may cooperate with the spool aperture of the first spool arm 61 and the spool aperture 65 of the second spool arm 63 by allowing rotation of the spool shaft 69. A first spool 9 and a second spool 10 may form a spool device which may be mounted on the spool shaft 69 to collect or strip fishing line 104. The first clamp arm 21 may include a first clamping slot 30, and the second clamp arm 23 may include a second clamping slot 32.

FIG. 2 illustrates a perspective view of the clamp device 100 of the present invention, and the clamp device 100 may include a first clamp member 1 which may include a first clamp arm 21 which may include a first clamping pivoting device 25 which may have a first inner surface 29 which may be concavely curved to clamp an object such as a fishing rod 102 and which may have a rectangular cross-section and may include a first clamping arm 21 connected to the first clamping pivoting device 25 and having a rectangular cross-section. The first clamping arm 21 may include a wide section 31 at a proximal end of the first clamping arm 21 and may include a first clamp slot 30. The wide section 31 may include a central aperture 33 which may be a vertical aperture to cooperate with a shaft 3.

The clamp device 100 may include a second clamp member 41 which may include a second clamp arm 23 which may include a second clamping pivoting device 27 which may have a second inner surface 31 which may be concavely curved to clamp an object by cooperating with the first inner surface 29 and which may have a rectangular cross-section and may include a second clamping arm 23 connected to the second clamping pivoting device 27 and having a rectangular cross-section. The first clamp pivoting device 25 pivots the second clamping pivoting device 27 by a pivoting shaft 34 which may extend between the first clamping pivoting device 25 and the second clamping pivoting device 27. The second clamping arm 23 may include a second clamping slot 32 to cooperate with a horizontal shaft 4.

The vertical shaft 3 may include a horizontal aperture 45 which may be threaded to cooperate with the horizontal shaft 4.

By turning the handle 14, the horizontal shaft 4 turns and depending on the direction of the rotation of the shaft 4, the first clamp member 1 may approach the second clamp member 41 to close the clamp, or the first clamp member 1 may move away from the second clamp member 41 to open the clamp.

The clamp device 100 additionally may include a spool member 2 which may include a base member 60 which may be connected to the first and second clamp member 1, 41. The base member 60 may include a first spool arm 61 which may extend from the base member 60 and a second spool arm 63 which may extend from the base member 60 and which may be positioned in an opposed relationship and parallel to the first spool arm 61. The first spool arm 61 may have a spool aperture 65 at a distal end of the first spool arm 61 which may be substantially horizontal, and the second spool arm 63 may have a mirror spool aperture 65 at the distal end of the second spool arm 63 and which may be substantially horizontal. A spool shaft may cooperate with the spool aperture of the first spool arm 61 and the spool aperture 65 of the second spool arm 63 by allowing rotation of the spool shaft 69. A first spool 9 and a second spool 10 may form a spool device which may be mounted on the spool shaft 69 to collect or strip fishing line 104.

FIG. 3 illustrates a perspective view of the clamp device of the present invention and illustrates the first spool 9, the second spool 10 and a spring pin 13 at a distal end of the shaft 4.

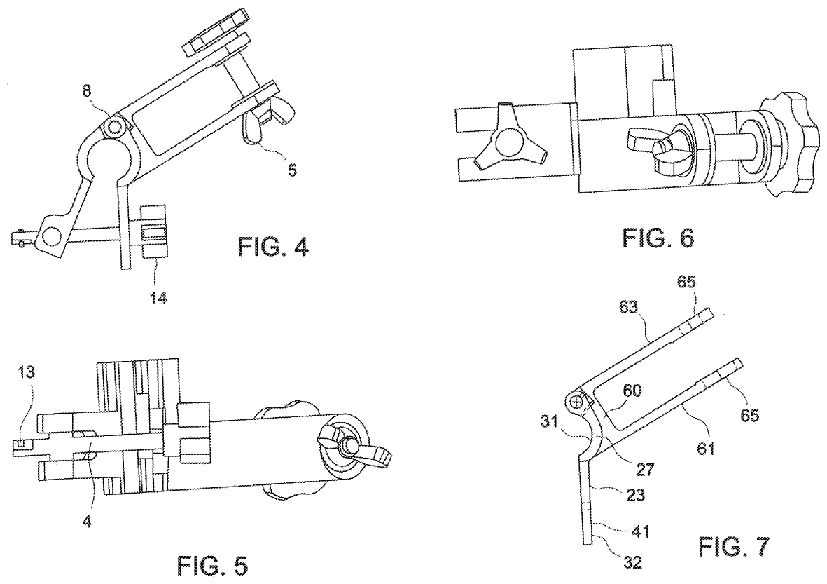

FIG. 4 illustrates a top view of the clamp device 100 of the present invention and illustrates the first clamp member 1, the horizontal shaft 4, the handle 11 for the horizontal shaft 4, the shaft 3, the first spacer 5, the second spacer 6, the spool member 2, and a bolt 51 which may be a wingnut attaching to the shaft 8.

FIG. 5 illustrates a side view of the clamping device 100 and illustrates the pin spring 13 for the horizontal shaft 4.

FIG. 6 illustrates a side view of the clamping device 100 and illustrates another pin spring 13a for the first clamp member 1.

FIG. 7 illustrates a sectional view of the clamping device 100 and illustrates the second clamp arm 23, the second clamp member 41, the second clamp slot 32, the second inner surface 31, the second clamping pivoting device 27, the base member 60, the first spool arm 61, the second spool arm 63, and the spool aperture 65.

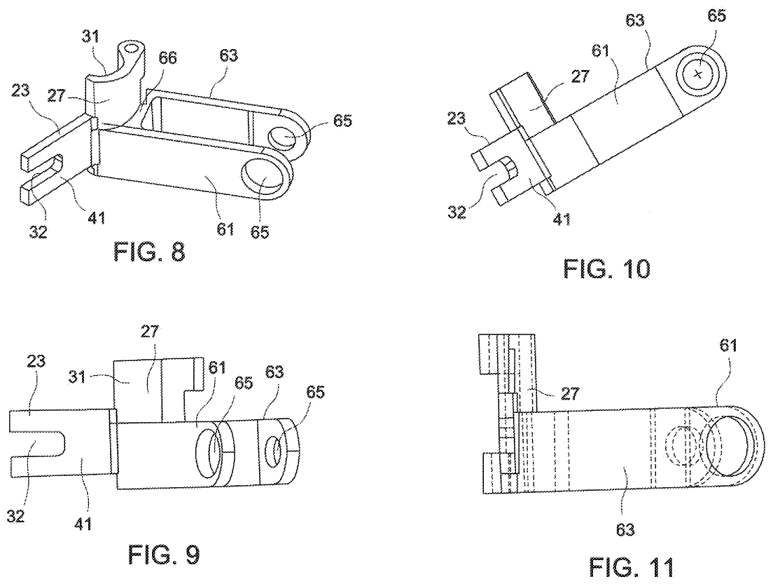

FIG. 8 illustrates a sectional view of the clamping device 100 and illustrates the second clamp arm 23, the second clamp member 41, the second clamp slot 32, the second inner surface 31, the second clamping pivoting device 27, the base member 60, the first spool arm 61, the second spool arm 63, and the spool aperture 65.

FIG. 9 illustrates a sectional view of the clamping device 100 and illustrates the second clamp arm 23, the second clamp member 41, the second clamp slot 32, the second inner surface 31, the second clamping pivoting device 27, the base member 60, the first spool arm 61, the second spool arm 63, and the spool aperture 65.

FIG. 10 illustrates a sectional view of the clamping device 100 and illustrates the second clamp arm 23, the second clamp member 41, the second clamp slot 32, the second inner surface 31, the second clamping pivoting device 27, the base member 60, the first spool arm 61, the second spool arm 63, and the spool aperture 65.

FIG. 11 illustrates a sectional view of the clamping device 100 and illustrates the second clamping pivoting device 27, the base member 60, the first spool arm 61, the second spool arm 63, and the spool aperture 65.

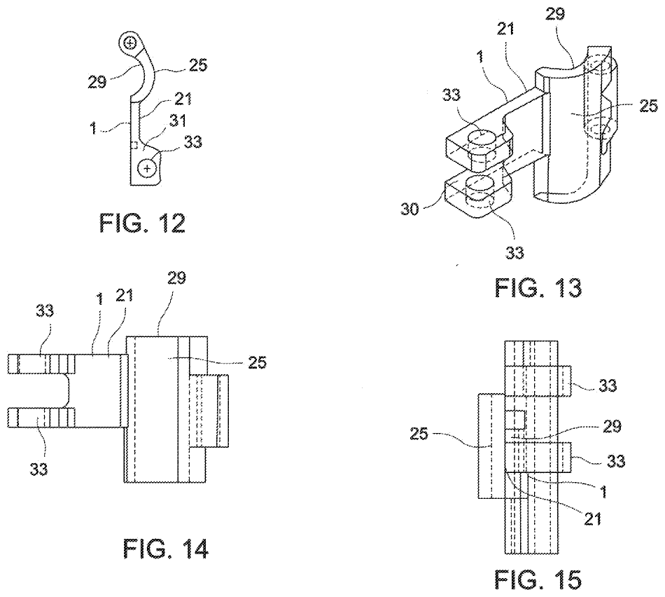

FIG. 12 illustrates a top view of the first clamp member 1 which may include the first clamping pivoting device 25, the first clamp arm 21, the first inner surface 29, the wide section 31 and the aperture 33.

FIG. 13 illustrates a perspective view of the first clamp member 1 which may include the first clamping pivoting device 25, the first clamp arm 21, the first inner surface 29, the wide section 31 and the aperture 33.

FIG. 14 illustrates a side view of the first clamp member 1 which may include the first clamping pivoting device 25, the first clamp arm 21, the first inner surface 29, the wide section 31 and the aperture 33.

FIG. 15 illustrates a back view of the first clamp member 1 which may include the first clamping pivoting device 25, the first clamp arm 21, the first inner surface 29, the wide section 31 and the aperture 33.

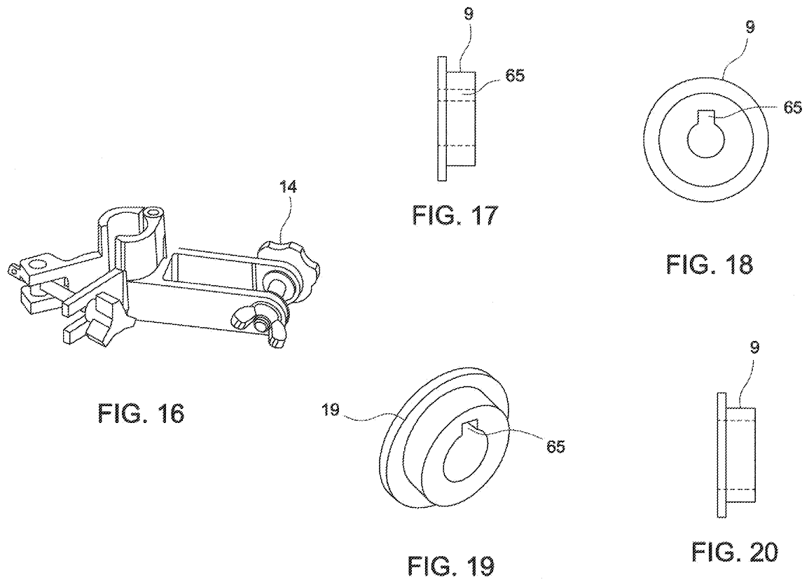

FIG. 16 illustrates a perspective view of the clamp device 100 and illustrates a handle 14 to rotate the first spool 9 and the second spool 10.

FIG. 17 illustrates a side view of the first spool 9 and illustrates a channel 65 in order to cooperate with the spool shaft 69.

FIG. 18 illustrates a front view of the first spool 9 and illustrates the channel 65 in order to cooperate with the spool shaft 9.

FIG. 19 illustrates a perspective view of the first spool 9 and illustrates the channel 65 to cooperate with the spool shaft 65.

FIG. 20 illustrates a side view of the second spool 10 which cooperates with the first spool 9.

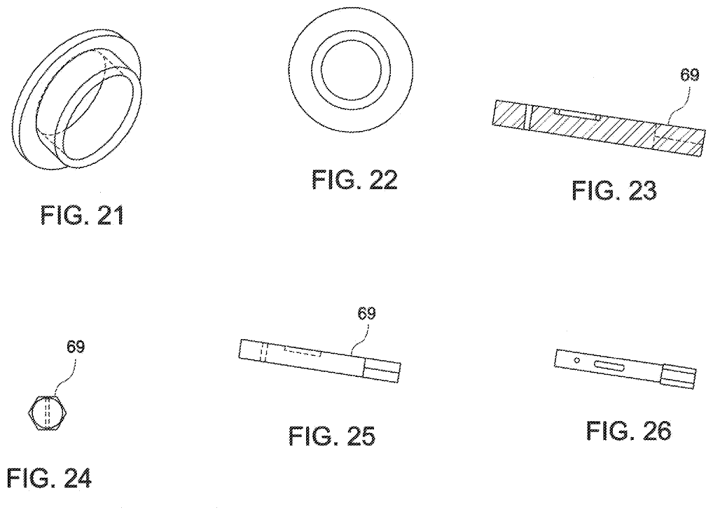

FIG. 21 illustrates a perspective view of the second spool 10 which cooperates with the first spool 9.

FIG. 22 illustrates a front view of the second spool 10 which cooperates with the first spool 9.

FIG. 23 illustrates a cross-sectional side view of the spool shaft 69 of the present invention.

FIG. 24 illustrates an end view of the spool shaft 69 of the present invention.

FIG. 25 illustrates a side view of the spool shaft 69 of the present invention.

FIG. 26 illustrates a top view of the spool shaft 69 of the present invention, and illustrates an upward extending member 71 which may extend from the spool shaft 69 and may engage the channel 65 of the first spool 9.

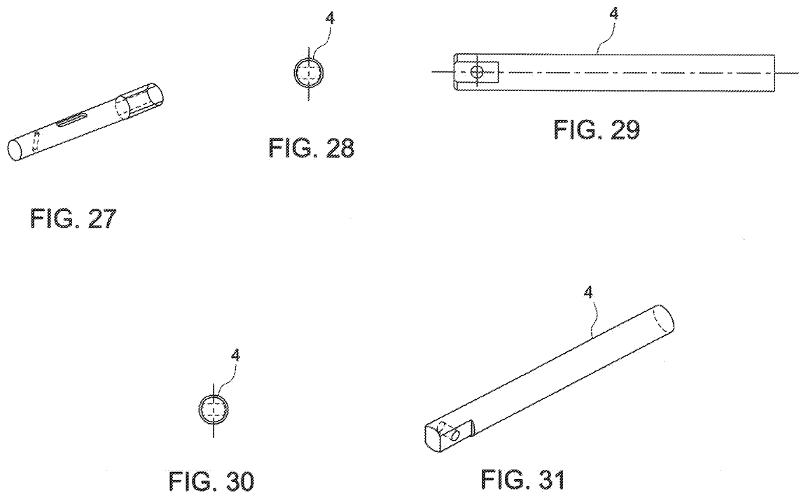

FIG. 27 illustrates a perspective view of the spool shaft 69 of the present invention, and illustrates an upward extending member 71 which may extend from the spool shaft 69 and may engage the channel 65 of the first spool 9.

FIG. 28 illustrates a first end view of the horizontal shaft 4 of the present invention.

FIG. 29 illustrates a top view of the horizontal shaft 4 of the present invention.

FIG. 30 illustrates a second end view of the horizontal shaft 4 of the present invention.

FIG. 31 illustrates a perspective view of the horizontal shaft 4 of the present invention.

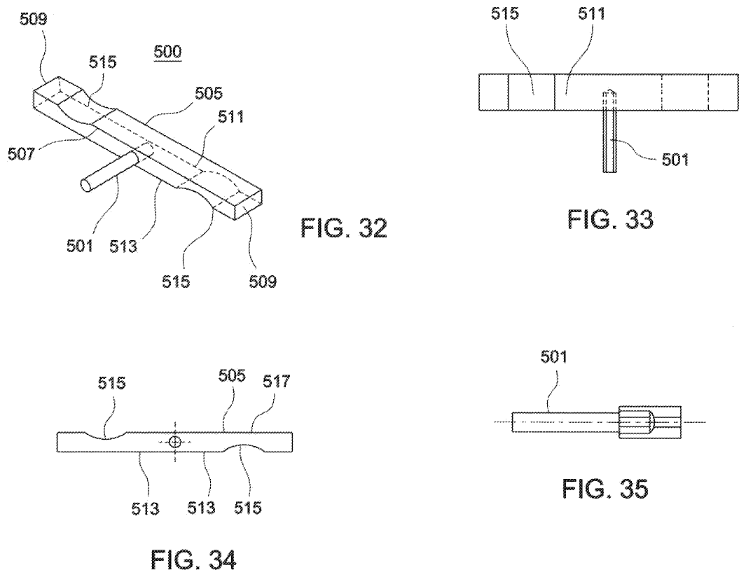

FIG. 32 illustrates a fishing reel driver 500 of the present invention which may cooperate with the handles of a fishing reel in order to allow the fishing reel to be rapidly operated with for example a drill. The fishing reel driver 500 may include a fishing reel driver arm 503 to cooperate with the fishing reel handle and a fishing reel driver shaft 501 to cooperate with the drill in order to automatically turn the fishing reel handle. The fishing reel driver 500 may be solid and may be formed from material such as metal, wood or other appropriate material. The fishing reel driver arm 503 may be a rectangle and may include a top surface 505, an opposing bottom surface 507, a pair of opposing side surfaces 509, a front surface 511 and a back surface 513.

The front surface 511 and the back surface 513 may include a first depression 515 and a second depression 517 which may extend across the width of the front surface 511 and the back surface 513 respectively. The first depression 515 and the second depression 517 may be on opposing sides, and each of the first depression 515 and the second depression 517 may cooperate with a respective handle of the fishing reel.

FIG. 33 illustrates a front view of the fishing reel device 500 and illustrates the front surface 511, the first depression 515, the fishing reel driver shaft 501. FIG. 33 additionally illustrates the second depression 517 in phantom line.

FIG. 34 illustrates a top view of the fishing reel driver 500 and illustrates the top surface 505, the front surface 511, the back surface 513, the first depression 515 and the second depression 519.

FIG. 35 illustrates a perspective view of the fishing reel driver shaft 501.

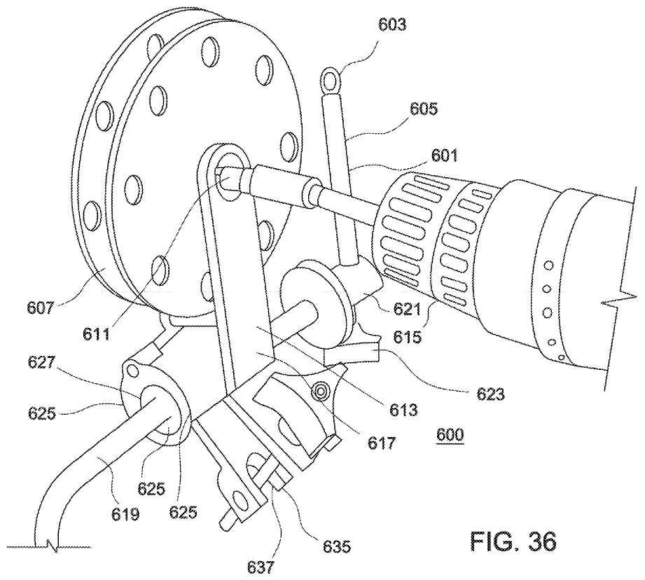

FIG. 36 illustrates a perspective view of the fish line reel device 600 which may be used to take up fishing line from a fishing reel or may be used to dispense fishing line for a fishing reel and which may be formed from rigid material such as metal, plastic, wood or other appropriate material. The fishing line reel device 600 may include a fishing line spool 607 which may rotate with a central shaft 611 which may extend axially in order to be coupled to a rotation device 615 which may be a power drill to rotate the central shaft 611 and the fishing line spool 607. The central shaft 611 may be rotatably supported by a pair of opposing holding arms 613 which may include a bearing for the central shaft 611. The holding arms 613 may be mounted on a first base member 617 which may be positioned on the fishing rod 619. The first base member 617 may be in a spaced relationship with a fishing line guide 601 which may include a second base member 621 which may be detachably connected to the fishing rod 619 by a fastener 623 which may be a threaded shaft and handle. The fishing line guide 601 may include a fishing line cylinder 603 to guide the fishing line and a fishing line post 605 which may be connected to the fishing line cylinder 603 and may be connected to the second base member 621. The fishing line reel device 600 may include a pair of opposed curve clamping members 625 which may be pivotably connected in order to releasably compress a fishing rod sleeve 627 which may be formed from flexible material and which may have a longitudinal slit 625 to allow the fishing rod sleeve 627 to be placed over the fishing rod 619.

The curve clamping members 625 may be connected to clamp arms 631 to allow the curve clamping members 625 to be clamped on to the fishing rod sleeve 627. The clamping arms 631 each may include a pair of opposing fingers 633 which may be in a spaced relationship. One of the pair of opposing fingers may include a traverse shaft 635 which may include a threaded aperture 637 to cooperate with a threaded shaft 639 which may connect to a handle 641 to rotate the threaded shaft 639 into the threaded aperture 637.

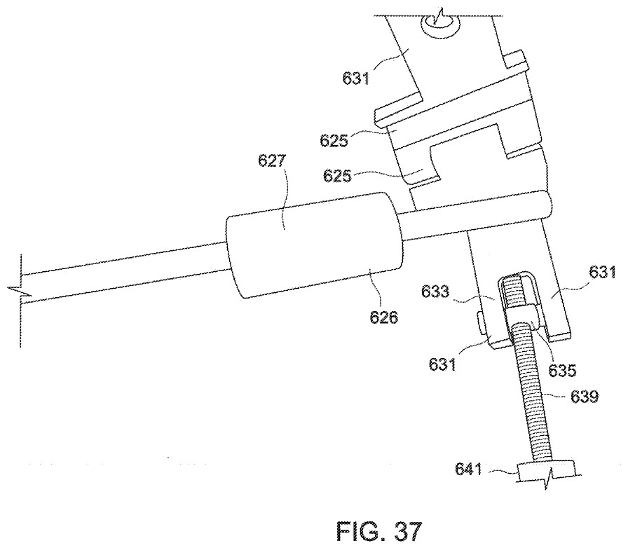

FIG. 37 illustrates a perspective view of a portion of the fish line reel device 600 in an open position which may be used to take up fishing line from a fishing reel or may be used to dispense fishing line for a fishing. The fishing line reel device 600 may include a pair of opposed curve clamping members 625 which may be pivotably connected in order to releasably compress a fishing rod sleeve 627 which may be formed from flexible material and which may have a longitudinal slit 626 to allow the fishing rod sleeve 627 to be placed over the fishing rod 619.

The curve clamping members 625 may be connected to clamp arms 631 to allow the curve clamping members 625 to be clamped on to the fishing rod sleeve 627. The clamping arms 631 each may include a pair of opposing fingers 633 which may be in a spaced relationship. One of the pair of opposing fingers may include a traverse shaft 635 which may include a threaded aperture 637 to cooperate with a threaded shaft 639 which may connect to a handle 641 to rotate the threaded shaft 639 into the threaded aperture 637.

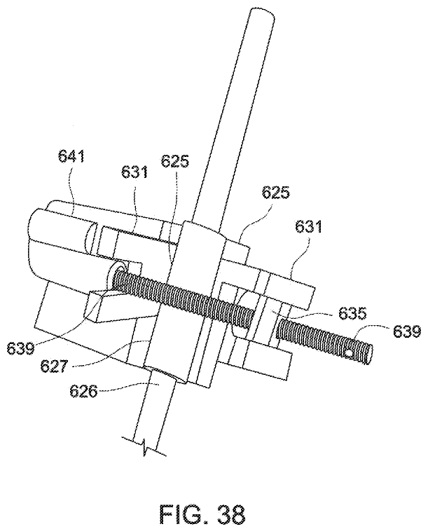

FIG. 38 illustrates a perspective view of a portion of the fish line reel device 600 in a closed position which may be used to take up fishing line from a fishing reel or may be used to dispense fishing line for a fishing. The fishing line reel device 600 may include a pair of opposed curve clamping members 625 which may be pivotably connected in order to releasably compress a fishing rod sleeve 627 which may be formed from flexible material and which may have a longitudinal slit 626 to allow the fishing rod sleeve 627 to be placed over the fishing rod 619.

The curve clamping members 625 may be connected to clamp arms 631 to allow the curve clamping members 625 to be clamped on to the fishing rod sleeve 627. The clamping arms 631 each may include a pair of opposing fingers 633 which may be in a spaced relationship. One of the pair of opposing fingers may include a traverse shaft 635 which may include a threaded aperture 637 to cooperate with a threaded shaft 639 which may connect to a handle 641 to rotate the threaded shaft 639 into the threaded aperture 637.

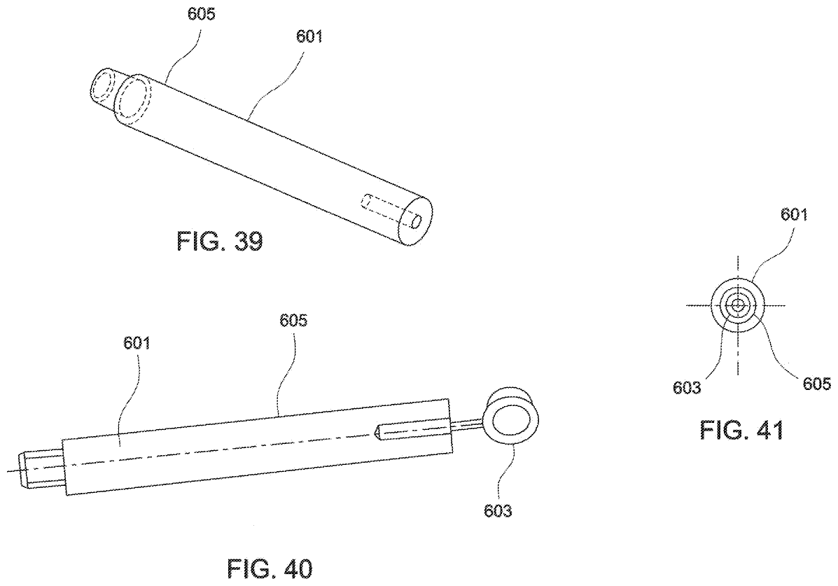

FIG. 39 illustrates a perspective view of the fishing line guide 601 and illustrates the fishing line post 605 which may be a cylinder.

FIG. 40 illustrates a side view of the fishing line guide 601 and illustrates the fishing line post 605 and the fishing line cylinder 603.

FIG. 41 illustrates an end view of the fishing line guide 601 and illustrates the fishing line post 605 and the fishing line cylinder 603.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A clamp device to clamp to a fishing pole and strip fishing line, comprising:
a first clamp member;
a second clamp member to pivotably connect to the first clamp member;
a spool member to connect to the first clamp member and the second clamp member to the fishing rod and to rotate and to strip fishing line.

2) A clamp device to clamp to a fishing pole and strip fishing line as in claim 1, wherein the first clamp member includes a first clamp pivoting device.

3) A clamp device to clamp to a fishing pole and strip fishing line as in claim 1, wherein the second clamp member includes a second clamp pivoting device.

4) A clamp device to clamp to a fishing pole and strip fishing line as in claim 1, wherein the first clamp member includes a first clamp arm.

5) A clamp device to clamp to a fishing pole and strip fishing line as in claim 1, wherein the second clamp member includes a second clamp arm.

6) A clamp device to clamp to a fishing pole and strip fishing line as in claim 4, wherein the first clamp arm includes a first clamp slot.

7) A clamp device to clamp to a fishing pole and strip fishing line as in claim 5, wherein the second clamp arm includes a second clamp slot.

8) A clamp device to clamp to a fishing pole and strip fishing line as in claim 1, wherein the spool member includes a first spool.

9) A clamp device to clamp to a fishing pole and strip fishing line as in claim 8, wherein the spool member includes a second spool.
